(19) United States
(12) Patent Application Publication
(10) Pub. No.: US 2025/0314913 A1
(43) Pub. Date: Oct. 9, 2025

(54) Ophthalmic Device with Air Vents and Integral Nose Pad

(71) Applicant: Fiat Lux Photonics LLC d/b/a TitanLabs, Berkeley, CA (US)

(72) Inventor: David Scott Andrews, Berkeley, CA (US)

(21) Appl. No.: 19/062,782

(22) Filed: Feb. 25, 2025

Related U.S. Application Data
(63) Continuation of application No. 18/627,012, filed on Apr. 4, 2024, now abandoned.

(51) Int. Cl. G02C 7/16; G02C 11/08

(52) U.S. Cl. CPC G02C 7/16; G02C 11/08

(57) ABSTRACT

An ophthalmic device includes: a frame; at least one eye cup detachably mounted to the frame and comprising an outer layer and an inner layer; and a plurality of air vents formed through the at least one eye cup, each defined by a first channel extending through the outer layer and a second channel extending through the inner layer, the first channel and the second channel angularly offset with respect to each other and (a) the first channel angularly offset from a direction normal to an inner surface of the outer layer at a point where a centerline of the first channel intersects a centerline of the second channel; and/or (b) the second channel angularly offset from a direction normal to an inner surface of the inner layer at the point where the centerline of the first channel intersects the centerline of the second channel.

### CROSS-REFERENCE TO RELATED APPLICATIONS

This application is a continuation of U.S. patent application Ser. No. 18/627,012, filed Apr. 4, 2024, which is incorporated herein by reference in its entirety.

### FIELD

The disclosure is directed to eyewear, and more particularly to ophthalmic devices including a frame and at least one eye cup detachably mounted to the frame.

### BACKGROUND

Conventional ophthalmic devices (e.g., goggles or eye glasses) may seal against the face like a diver's mask or include eye cups designed in part to prevent light from reaching the wearer's eye except through the lens or to allow air to pass therethrough. However, such ophthalmic devices are often bulky, uncomfortable, unattractive (e.g., ski goggles or cocoon glasses designed to be worn over standard glasses), and/or are incapable of providing both of these benefits, namely preventing light from passing therethrough while allowing air to pass therethrough.

Additionally, conventional eyeglasses are incapable of making a substantially light-tight seal against the wearer's face. Nose pads that are formed separately from the eye cups or wrap around lenses result in gaps between the nose pads and eye cups or nose pad and lens, which allows light to pass through the gaps toward the wearer's eyes.

Further yet, conventional ophthalmic devices may include eye cups that are made of a single material. When a soft material is used, the material tends to transmit more light (i.e., allows more light to pass therethrough) and is susceptible to collapsing or breaking away from the frame of the device.

As such, it would be desirable to provide an ophthalmic device resembling standard eyeglasses with eye cups having one or more improved mechanisms for (1) retarding light from passing therethrough while permitting air to pass therethrough, (2) forming a substantially gapless and substantially light-tight seal via the integrally-formed nose pad and eye cup, (3) use of different materials in the eye cup to provide rigidity and support, an ergonomic fit, and prevent light that does not pass through the lens/filter system from reaching the wearer's eyes.

### BRIEF SUMMARY

In a first aspect, an ophthalmic device is provided. The ophthalmic device incudes a frame. The ophthalmic device further includes at least one eye cup. The at least one eye cup is detachably mounted to the frame. The at least one cup comprises an outer layer. The at least one cup further comprises an inner layer. The ophthalmic device further includes a plurality of air vents. The plurality of air vents are formed through the at least one eye cup. Each of the plurality of air vents is defined by a first channel. The first channel extends though the outer layer. Each of the plurality of air vents is further defined by a second channel. The second channel extends through the inner layer. The first channel and the second channel are angularly offset with respect to each other. The first channel is angularly offset from a direction normal to an inner surface of the outer layer at a point where the center line of the first channel intersects with the centerline of the second channel and/or the second channel is angularly offset from a direction normal to an inner surface of the inner layer at the point where the center line of the first channel intersects with the center line of the second channel.

In a second aspect, an ophthalmic device is provided. The ophthalmic device includes a frame. The ophthalmic device further includes at least one eye cup. The at least one eye cup is detachably mounted to the frame. The at least one cup comprises an inner layer. The inner layer is formed from a first material. The at least one cup further comprises an outer layer. The outer layer is at least partially wrapped about the inner layer. The outer layer is formed from a second material. The second material is different from the first material.

In a third aspect, an ophthalmic device is provided. The ophthalmic device includes a frame. The ophthalmic device further includes at least one eye cup. The at least one eye cup is detachably mounted to the frame. The ophthalmic device further includes a nose pad. The nose pad is integrally formed with the at least one eye cup. The nose pad and the at least one eye cup collectively form a substantially gapless and substantially light-tight seal. The seal is configured to retard light from passing therethrough.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 shows an isometric perspective view from the front of an ophthalmic device according to an illustrative embodiment of the present disclosure;

FIG. 2 shows an isometric perspective view from a rear of the ophthalmic device of FIG. 1;

FIG. 3 shows a side perspective view of the ophthalmic device of FIG. 1;

FIG. 4 shows an exploded view of the ophthalmic device of FIG. 1;

FIG. 5 shows an isometric perspective view from a front of an eye cup of the ophthalmic device of FIG. 1 according to an illustrative embodiment of the present disclosure;

FIG. 6 shows a side perspective view of the eye cup of FIG. 5;

FIG. 7 shows an air vent of the eye cup of FIG. 6 according to an illustrative embodiment of the present disclosure;

FIG. 8 shows a detailed cross-sectional view of an air vent of the eye cup of FIG. 5 taken along line 8-8 of FIG. 6;

FIG. 9A shows a side view of an inner layer of the eye cup of FIG. 5 according to an illustrative embodiment of the present disclosure;

FIG. 9B shows a side view of an outer layer of the eye cup of FIG. 5 according to an illustrative embodiment of the present disclosure;

FIG. 10 shows an isometric perspective view of a user wearing the ophthalmic device of FIG. 1 with the right side lenses removed to shown additional features;

FIG. 11A shows a rear view of the frame front of the ophthalmic device of FIG. 1;

FIG. 11B shows a cross-sectional view of a portion of the frame front of the ophthalmic device of FIG. 1 taken along line 11-11 of FIG. 11A;

FIG. 11C shows a top view of the frame front of the ophthalmic device of FIG. 1;

FIG. 12A shows a side perspective view of the eye cup of FIG. 5; and

FIG. 12B shows a detailed cross-sectional view of the eye cup of FIG. 5 taken along line 12-12 of FIG. 12A with a filter/negative lens fixedly secured within the eye cup.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

The term “angularly offset” refers to two surfaces that are not a linear pair (i.e., their respective angles do not sum to 180°). The terms “filter” and “lens” are used interchangeably herein because a lens (e.g., a corrective (Rx) lens) may contain a polarizing film and function as a corrective lens and a polarizing filter at the same time. Furthermore, in the context of eyeglasses, the term “lens” is used herein in a broad sense to refer to any optical element that is mounted in the frame front, notwithstanding whether such optical element has any corrective powers such as specials or attenuates/only filters light such as pure sunglasses.

With reference to the drawings, the ophthalmic devices are illustrated, by way of non-limiting example, eyeglasses. Notwithstanding, those skilled in the art will recognize that the present disclosure, including the mechanisms and designs described herein, can be implemented in other suitable ophthalmic devices, such as goggles and protective eyewear.

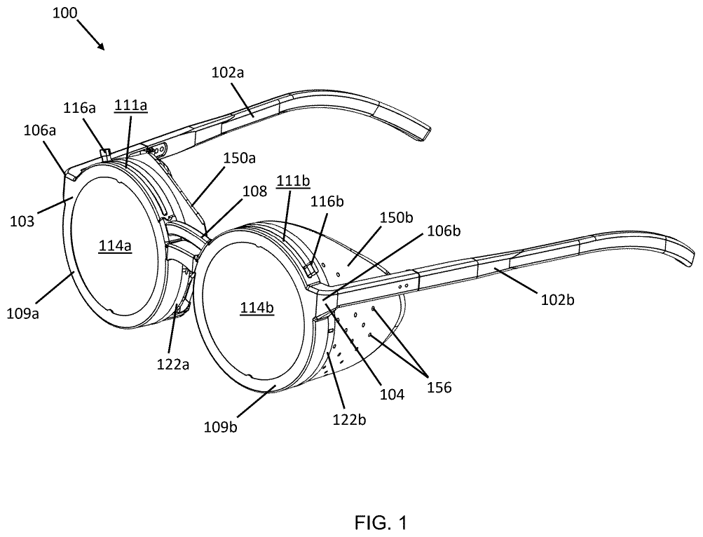

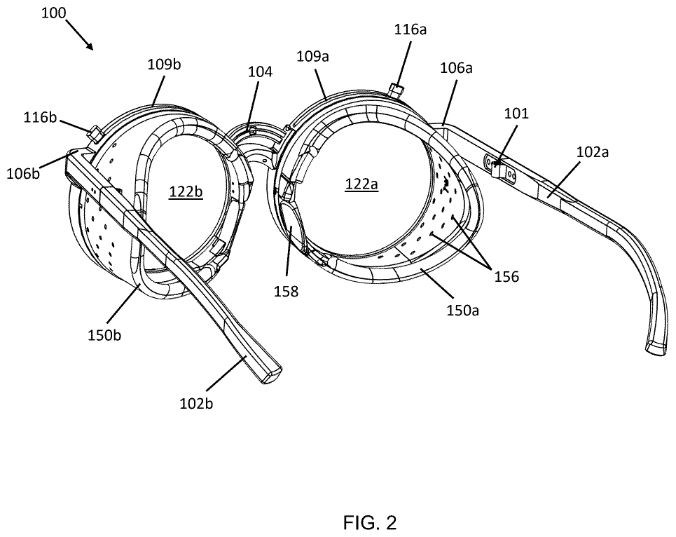

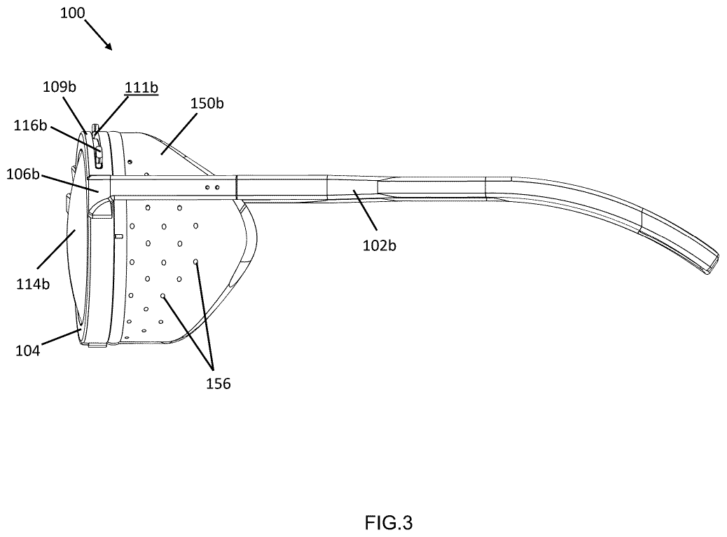

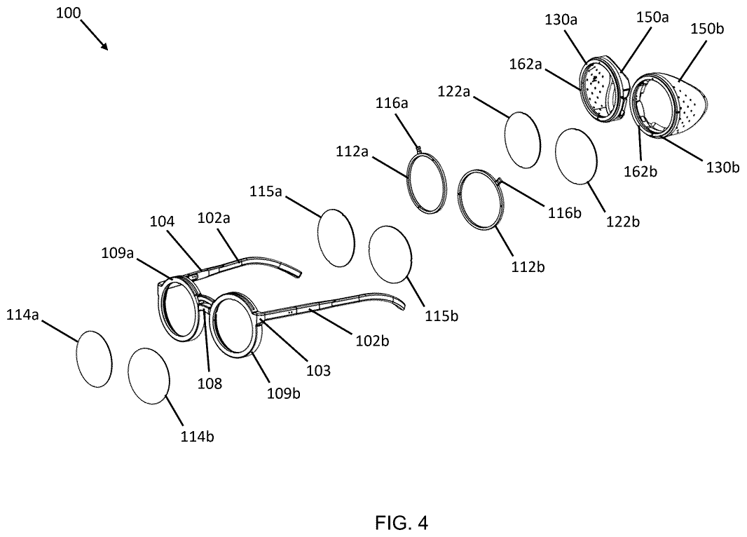

FIGS. 1-4 show an ophthalmic device 100 according to an illustrative embodiment of the present disclosure. In particular, FIG. 1 is an isometric perspective view from a front of the ophthalmic device 100, FIG. 2 is an isometric perspective view from a rear of the ophthalmic device 100, FIG. 3 is a side perspective view of the ophthalmic device 100, and FIG. 4 is an exploded view of the ophthalmic device 100.

As illustrated, the ophthalmic device 100 includes a frame 104. In variations, the ophthalmic device 100 may define or include a pair of end pieces 106a, 106b defined at opposing terminal sides of the frame front 103. In variations, the ophthalmic device 100 may further include a pair of temple arms 102a, 102b extending outwardly away from respective ones of the end pieces 106a, 106b of the frame front 103 on opposing sides thereof. In variations, the frame front 103 may include a pair of lens holders 109a, 109b interconnected by a bridge 108. In variations, the frame 104 is defined as including a frame front 103 connected to temple arms 102 through the use of respective hinges 101, end pieces 106 extending rearwardly such that when a corresponding hinge 101 is folded inward, it can achieve an angle of 90°+/−10° without the temple arm 102 contacting the eyecups 150, thereby making the eyewear compact enough to fit into standard eyeglass cases.

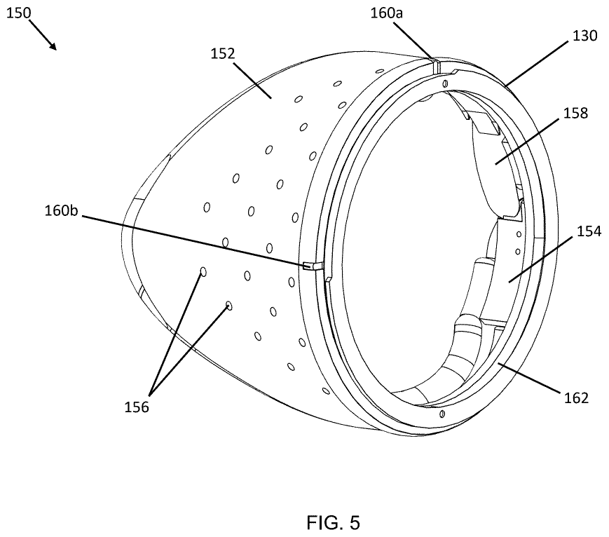

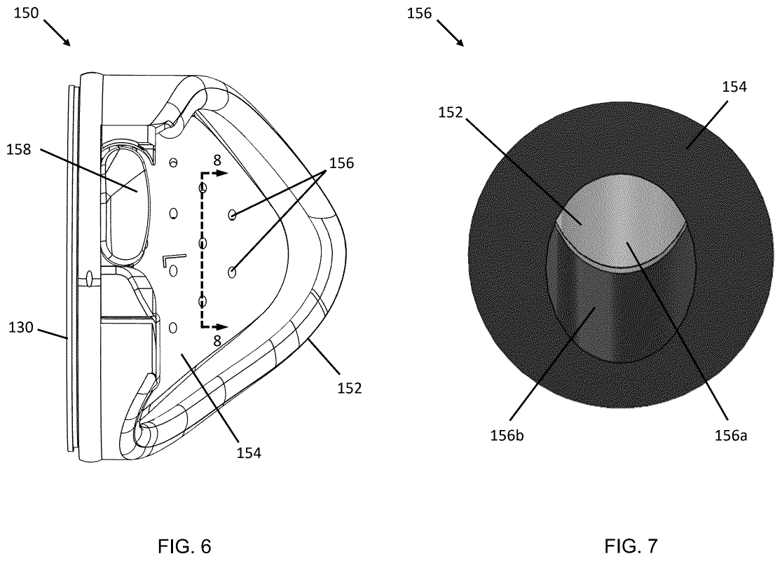

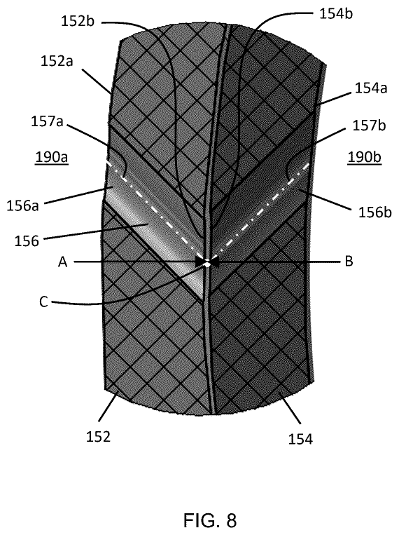

With continued reference to FIGS. 1-4 and further reference to FIGS. 5-8, the ophthalmic device 100 includes a pair of eye cups 150a, 150b. In variations, each eye cup may be detachably mounted to the frame, such as to a respective one of the tongues or rings 130a, 130b. FIG. 5 and FIG. 6 show one such eye cup 150 according to an illustrative embodiment of the present disclosure. In particular, FIG. 5 is an isometric perspective view of the eye cup 150, FIG. 6 is a side perspective of the eye cup 150, FIG. 7 shows an air vent of the eye cup of FIG. 6 (inside out) according to an illustrative embodiment, and FIG. 8 is a detailed cross-sectional view of a single air vent 156 of the eye cup 150 taken along line 8-8 of FIG. 6.

Each eye cup of the pair of eye cups 150a, 150b (shortly, eye cup 150) is generally configured to seal against the wearer's face and protect the wearer's eyes from debris and light that might otherwise pass to the wearer's eyes without passing through the lenses. For example, patients with photophobia (an extreme sensitivity to light in one or both eyes, such as may be caused by optic neuritis—an inflammation of the optic nerve often caused by multiple sclerosis—other common root causes of photophobia include traumatic brain injury, diabetes, migraines, thyroid eye diseases, infections, inflammation, and/or damage to the cornea, retina, or other parts of the eye), it may be particularly desirable that the ophthalmic device seals tightly against the wearer's face (including the wearer's nose and eye sockets) to block light from passing through to the wearer's eyes except through the lenses. In variations, the eye cup 150 may be contoured to seal tightly against the wearer's face.

The need for a substantially light-tight eye cup comes, in part, from the ability of the ophthalmic device 100 to variably block from 30% to 99.98% of light coming through the lens/filter system. When the wearer's sensitivity to light is high and the light attenuation is high (e.g., 99.9%), even a small amount of leaking light (e.g., 1%)—such as through a gap created by the nose piece—is a noticeable problem as it is ten times more intense than light passing through the lens system. In contrast, typical sunglasses block, at most, 95% of light, such that a leak of about 1% from the side would result in a less noticeable 20% increase.

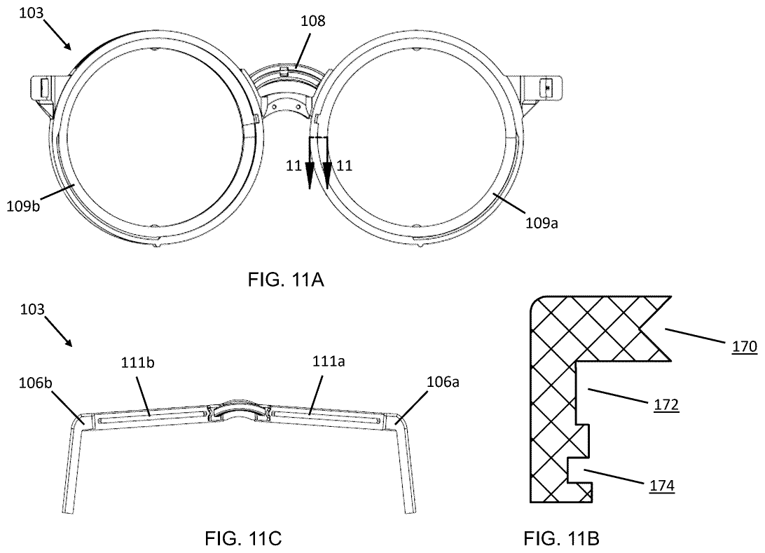

In variations, the lens holders 109a, 109b may include a groove 174 (refer to FIG. 11B) or other feature configured to engage a protrusion (not shown) or corresponding ring 130a, 130b so that the eye cup 150 is detachably mounted on the corresponding ring on the corresponding lens holder (e.g., by a tongue 130-and-groove 174 joint or other mating means).

In variations, each eye cup 150 may include an outer layer 152 and an inner layer 154, as described herein. As illustrated, in variations, the eye cup 150 may include a plurality of air vents 156 (shortly, vents) formed therethrough. The vents 156 may be spaced apart from one another in any pattern as desired to suit a particular application. By way of non-limiting example, the vents 156 may be arranged on the eye cup 150 such that the vents 156 are spaced equidistantly from immediately adjacent vents. Any number of vents 156 may be provided as desired to suit a particular application. By way of non-limiting example: in one variation, each eye cup 156 may include at least two vents formed therethrough; in another variation, each eye cup 156 may include at least three vents formed therethrough; in another variation, each eye cup 156 may include at least four vents formed therethrough; in another variation, each eye cup 156 may include at least five vents formed therethrough; in another variation, each eye cup 156 may include at least six vents formed therethrough; in another variation, each eye cup 156 may include at least seven vents formed therethrough; in another variation, each eye cup 156 may include at least eight vents formed therethrough; in another variation, each eye cup 156 may include at least nine vents formed therethrough; in another variation, each eye cup 156 may include at least 10 vents formed therethrough; in another variation, each eye cup 156 may include at least 11 vents formed therethrough; in another variation, each eye cup 156 may include at least 12 vents formed therethrough; in another variation, each eye cup 156 may include at least 13 vents formed therethrough; in another variation, each eye cup 156 may include at least 14 vents formed therethrough; in another variation, each eye cup 156 may include at least 15 vents formed therethrough; in another variation, each eye cup 156 may include at least 16 vents formed therethrough; in another variation, each eye cup 156 may include at least 17 vents formed therethrough; in another variation, each eye cup 156 may include at least 18 vents formed therethrough; in another variation, each eye cup 156 may include at least 19 vents formed therethrough; in another variation, each eye cup 156 may include at least 20 vents formed therethrough; in another variation, each eye cup 156 may include at least 21 vents formed therethrough; in another variation, each eye cup 156 may include at least 22 vents formed therethrough; and in another variation, each eye cup 156 may include at least 23 vents formed therethrough.

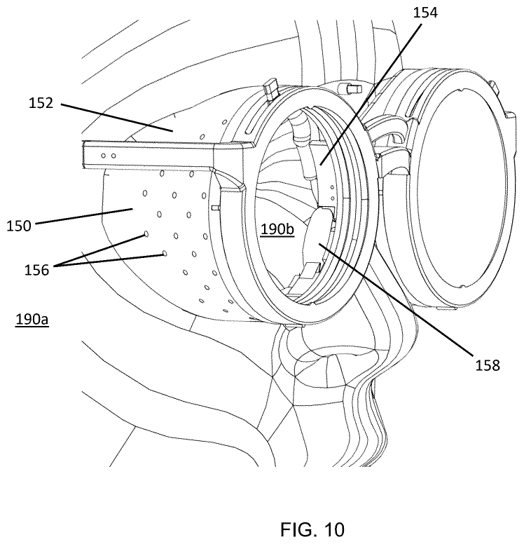

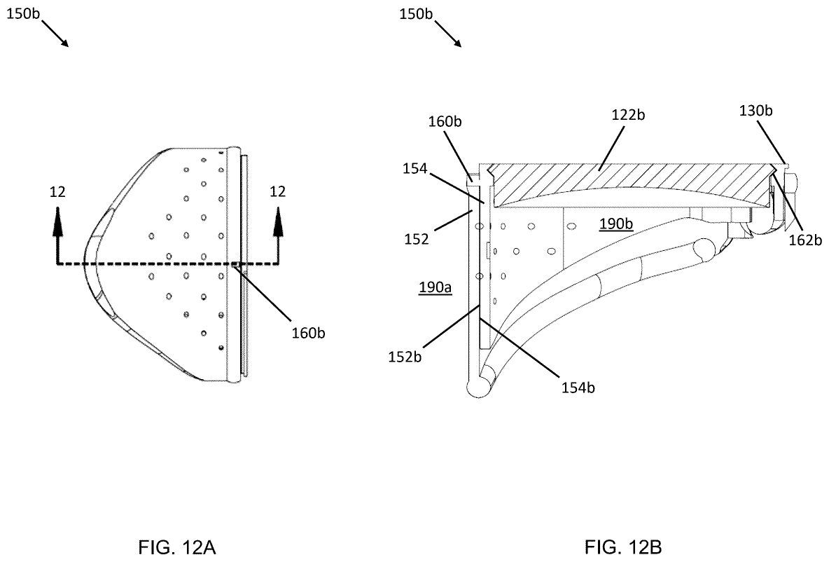

Each vent 156 is generally configured to allow air and/or moisture to pass therethrough while retarding light from passing therethrough. In variations, the vents 156 may be formed from one or more materials designed to promote the passage of air and/or moisture and to inhibit the passage of light therethrough. In the same or other variations, the vents 156 may be formed from one or more materials adapted to scatter and absorb—more than reflect—light. Any amount of light passing through the vent is directed away from a direct line of sight of the wearer's eye. In this regard, the specific shape and/or angling of the vents 156 can be selected to achieve any one or more of the foregoing features, as described herein. For example, in variations, the vents 156 may be defined by a first channel 156a extending through the outer layer 152 of the eye cup 150 and a second channel 156b extending through the inner layer 154 of the eye cup 150, such as is illustrated in FIG. 7 and FIG. 8. In variations, the first channel 156a and the second channel 156b may be angularly offset from each other, such as is illustrated in FIG. 8. Implementing the first channel 156a and the second channel 156b such that they are angularly offset from each other may advantageously retard light passage through the vent and/or diffuse any light that does pass through the vent while nevertheless allowing air and/or moisture to pass through the vent. Structuring the vents 156 to allow air and/or moisture to pass from an environment 190a external to the eve cup through the vents 156 to an environment 190b internal to the eye cup (refer to FIG. 8, FIG. 10, and FIG. 12B) while retarding light from passing therethrough may also advantageously prevent accumulation of moisture causing eye irritation and/or condensation on the surfaces of the filters or lenses.

The first channel 156a and the second channel 156b may be angularly offset from each other by any angle as desired to suit a particular application. By way of non-limiting example, the first channel may be angularly offset from the second channel by from 5° to 175°, including by from 45° to 135°, further particularly including by from 80° to 100°, yet further specifically including by 90°. By way of further non-limiting example: in one variation, the first channel may be angularly offset from the second channel by about 5°; in another variation, the first channel may be angularly offset from the second channel by about 10°; in another variation, the first channel may be angularly offset from the second channel by about 15°; in another variation, the first channel may be angularly offset from the second channel by about 20°; in another variation, the first channel may be angularly offset from the second channel by about 25°; in another variation, the first channel may be angularly offset from the second channel by about 30°; in another variation, the first channel may be angularly offset from the second channel by about 35°; in another variation, the first channel may be angularly offset from the second channel by about 40°; in another variation, the first channel may be angularly offset from the second channel by about 45°; in another variation, the first channel may be angularly offset from the second channel by about 50°; in another variation, the first channel may be angularly offset from the second channel by about 55°; in another variation, the first channel may be angularly offset from the second channel by about 60°; in another variation, the first channel may be angularly offset from the second channel by about 65°; in another variation, the first channel may be angularly offset from the second channel by about 70°; in another variation, the first channel may be angularly offset from the second channel by about 75°; in another variation, the first channel may be angularly offset from the second channel by about 80°; in another variation, the first channel may be angularly offset from the second channel by about 85°; in another variation, the first channel may be angularly offset from the second channel by about 90°; in another variation, the first channel may be angularly offset from the second channel by about 95°; in another variation, the first channel may be angularly offset from the second channel by about 100°; in another variation, the first channel may be angularly offset from the second channel by about 105°; in another variation, the first channel may be angularly offset from the second channel by about 110°; in another variation, the first channel may be angularly offset from the second channel by about 115°; in another variation, the first channel may be angularly offset from the second channel by about 120°; in another variation, the first channel may be angularly offset from the second channel by about 125°; in another variation, the first channel may be angularly offset from the second channel by about 130°; in another variation, the first channel may be angularly offset from the second channel by about 135°; in another variation, the first channel may be angularly offset from the second channel by about 140°; in another variation, the first channel may be angularly offset from the second channel by about 145°; in another variation, the first channel may be angularly offset from the second channel by about 150°; in another variation, the first channel may be angularly offset from the second channel by about 155°; in another variation, the first channel may be angularly offset from the second channel by about 160°; in another variation, the first channel may be angularly offset from the second channel by about 165°; in another variation, the first channel may be angularly offset from the second channel by about 170°; and in another variation, the first channel may be angularly offset from the second channel by about 175°.

In variations, the first channel 156a may be angularly offset from a direction A normal to an inner surface 152b of the outer layer 152 at a point C where a centerline 157a of the first channel 156a extending through the outer layer 152 of the eye cup 150 intersects a centerline 157b of the second channel 156b extending through the inner layer 154 of the eye cup 150 (e.g., where the outer layer 152 mates with the inner layer 154 and the first channel 156a interfaces with the second channel 156b) and/or the second channel 156b may be angularly offset from a direction B normal to an inner surface 154b of the inner layer 154 at the point C, such as is illustrated in FIG. 8. In variations, directions A, B and point C are defined by the relationships that follow. In variations, direction A and direction B may be angularly offset from one another by 180°. In variations, direction A and/or direction B may be normal to the curve formed at the intersection of the outer layer 152 and the inner layer 154 in a plane containing both centerlines 157a and 157b of a given air vent at point C (see FIG. 8), such that a centerline of the first channel and/or a centerline of the second channel intersects the point C. In the variation illustrated in FIG. 8: direction A is angularly offset from direction B by 180°; direction A is normal to the inner surface 152b of the outer layer 152 at point C, such that the centerline 157a of the first channel 156a extending through the outer layer 152 of the eye cup 150 intersects point C; the centerline 157a of the first channel 156a is angularly offset from the normal direction A by 45°; direction B is normal to the inner surface 154b of the inner layer 154 at point C, such that the centerline 157b of the second channel 156b extending through the inner layer 154 of the eye cup 150 intersects point C; the centerline 157b of the second channel 156b is angularly offset from the normal direction B by 45°; and the centerline 157a of the first channel 156a is angularly offset from the centerline 157b of the second channel 156b by 90°, although other variations are not so limited.

In some variations, the first channel 156a is angularly offset from the direction A, but the second channel 156b is not angularly offset from the direction B. In other variations, the first channel 156a is not angularly offset from the direction A, but the second channel 156b is angularly offset from the direction B. In yet other variations, the first channel 156a is angularly offset from the direction A, and the second channel 156b is also angularly offset from the direction B. The first channel 156a may be angularly offset from the direction A and/or the second channel 156b may be angularly offset from the direction B by any angle as desired to suit a particular application. By way of non-limiting example, the first channel 156a may be angularly offset from the direction A by from 5° to 85°, including by from 35° to 65°, further particularly including by 45°, and/or the second channel 156b may be angularly offset from the direction B by from 5° to 85°, including by from 35° to 65°, further particularly including by 45°. By way of further non-limiting example: in one variation, the first channel 156a may be angularly offset from the direction A by about 5° and/or the second channel 156b may be angularly offset from the direction B by about 5°; in another variation, the first channel 156a may be angularly offset from the direction A by about 10° and/or the second channel 156b may be angularly offset from the direction B by about 10°; the first channel 156a may be angularly offset from the direction A by about 15° and/or the second channel 156b may be angularly offset from the direction B by about 15°; the first channel 156a may be angularly offset from the direction A by about 20° and/or the second channel 156b may be angularly offset from the direction B by about 20°; the first channel 156a may be angularly offset from the direction A by about 25° and/or the second channel 156b may be angularly offset from the direction B by about 25°; the first channel 156a may be angularly offset from the direction A by about 30° and/or the second channel 156b may be angularly offset from the direction B by about 30°; the first channel 156a may be angularly offset from the direction A by about 35° and/or the second channel 156b may be angularly offset from the direction B by about 35°; the first channel 156a may be angularly offset from the direction A by about 40° and/or the second channel 156b may be angularly offset from the direction B by about 40°; the first channel 156a may be angularly offset from the direction A by about 45° and/or the second channel 156b may be angularly offset from the direction B by about 45°; the first channel 156a may be angularly offset from the direction A by about 50° and/or the second channel 156b may be angularly offset from the direction B by about 50°; the first channel 156a may be angularly offset from the direction A by about 60° and/or the second channel 156b may be angularly offset from the direction B by about 60°; the first channel 156a may be angularly offset from the direction A by about 65° and/or the second channel 156b may be angularly offset from the direction B by about 65°; the first channel 156a may be angularly offset from the direction A by about 70° and/or the second channel 156b may be angularly offset from the direction B by about 70°; the first channel 156a may be angularly offset from the direction A by about 75° and/or the second channel 156b may be angularly offset from the direction B by about 75°; the first channel 156a may be angularly offset from the direction A by about 80° and/or the second channel 156b may be angularly offset from the direction B by about 80°; and the first channel 156a may be angularly offset from the direction A by about 85° and/or the second channel 156b may be angularly offset from the direction B by about 85°.

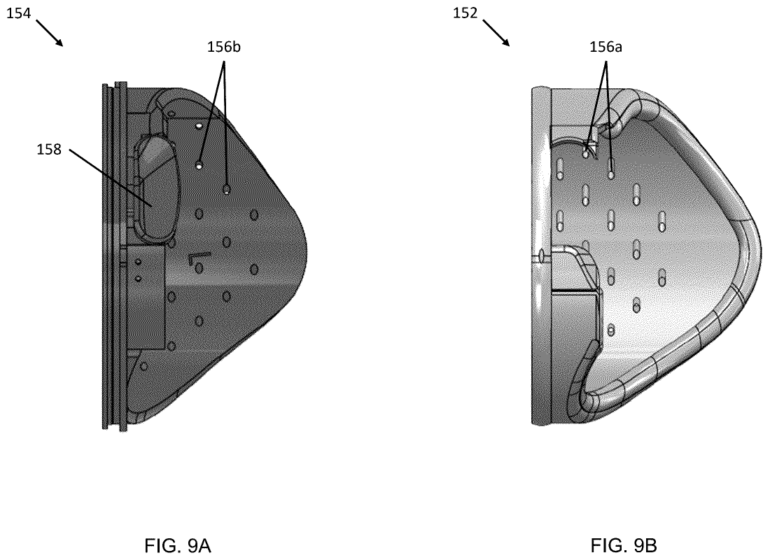

Turning to FIG. 9A and FIG. 9B, which show side views of the inner layer 154 and the outer layer 152 of the eye cup 150, respectively, a side view of an inner layer of the eye cup of FIG. 5 according to an illustrative embodiment of the present disclosure, the inner layer 154 and the outer layer 152 are shown according to one illustrated embodiment. In variations, the inner layer 154 of the eye cup 150 may be formed from a first material, and the outer layer 152 of the eye cup 150 may be formed from a second material. In variations, the second material from which the outer layer 152 of the eye cup 150 is formed may be different from the first material from which the inner layer 154 of the eye cup 150 is formed, such that the eye cup 150 is formed from at least two different materials.

As may be understood with further reference to FIG. 5 and FIG. 6, the outer layer 152 of the eye cup 150 may, in variations, be at least partially wrapped about the inner layer 154 of the eye cup 150. In such variations, the outer layer 152 of the eye cup 150 may encompass and extend beyond at least a portion of an outer edge of the inner layer 154 of the eye cup 150 such that the wearer's face generally contacts the softer outer layer 152 of the eye cup 150 without contacting (or with only limited contact with, such as contact between the wearer's nose and a nose pad 158, as described herein) the inner layer 154 of the eye cup 150, such as is illustrated in FIG. 10.

In variations, the first material from which the inner layer 154 of the eye cup 150 is formed may be designed to provide structure and/or rigidity to the softer outer layer 152 of the eye cup 150 (and, in variations, to the inner layer 154 of the eye cup 150 about which the outer layer 152 of the eye cup 150 is wrapped) such that eye cup 150 is not susceptible to undesirably collapsing or breaking away during normal use. In the same or other variations, the first material from which the inner layer 154 of the eye cup 150 is formed may be designed to provide a strong material (e.g., a rigid surface) through which the eye cup 150 may be detachably mounted to the frame 104 and/or to prevent debris or projectiles from reaching or contact the wearer's eye. In the same or yet other variations, the first material from which the inner layer 154 of the eye cup 150 is formed may be designed to be at least partially opaque so as to prevent light from passing therethrough to the wearer's eye, such as by absorbing, scattering, and/or reflecting any such light. In variations, the first material from which the inner layer 154 of the eye cup 150 is formed may be designed to block at least 75% of light from passing therethrough, including to block at least 80% of light from passing therethrough, including to block at least 85% of light from passing therethrough, including to block at least 90% of light from passing therethrough, including to block at least 95% of light from passing therethrough, including to block at least 99% of light from passing therethrough, and including to block greater than 99.9% of light from passing therethrough. By way of non-limiting example, the first material from which the inner layer 154 of the eye cup 150 is formed may, in variations, be a rigid plastic material. By way of further non-limiting example, the first material from which the inner layer 154 of the eye cup 150 is formed may be or include nylon, zylonite or cellulose acetate, acetate, propionate, polyurethane, acrylonitrile butadiene styrene (ABS), and/or combinations thereof.

In variations, the second material from which the outer layer 152 of the eye cup 150 is formed may be designed to provide comfort and ergonomics to the outer layer 152 of the eye cup 150 (and, in variations, to the inner layer 154 of the eye cup 150 about which the outer layer 152 of the eye cup 150 is wrapped) to provide a more comfortable and ergonomic experience between the eye cup 150 and the wearer's face (such as is illustrated in FIG. 10). In the same or other variations, the second material from which the outer layer 152 of the eye cup 150 is formed may be designed to form-fit or otherwise at least partially mold to a portion of the wearer's face when brought into contact therewith, which may further result in a substantially gapless seal between the outer layer 152 of the eye cup 150 and the wearer's face (e.g., the facial structures surrounding the wearer's eye), thereby prevent light from passing to the wearer's eye except through the filter(s) or lens(es) (e.g., two filters or lenses in the frame 104 and one in the eye cup 150). In variations, the outer layer 152 of the eye cup 150 may be designed with such that an outer edge thereof designed to contact the wearer's face has a radial or semi-radial profile to improve the aforementioned sealing effect and providing a comfortable experience for the wearer. In variations, the second material from which the outer layer 152 of the eye cup 150 is formed may be designed to block at least 65% of light from passing therethrough, including to block at least 70% of light from passing therethrough, including to block at least 75% of light from passing therethrough, including to block at least 80% of light from passing therethrough, including to block at least 85% of light from passing therethrough, and including to block greater than 85% of light from passing therethrough. By way of non-limiting example, the second material from which the outer layer 152 of the eye cup 150 is formed may, in variations, be a flexible rubber or rubber-like material. By way of further non-limiting example, the second material from which the outer layer 152 of the eye cup 150 is formed may be or include silicone, a silicone-like material, elastomeric silicone-urethane, a biocompatible rubber-like material, and/or combinations thereof.

As described herein, in variations, the vents 156 defined in the eye cup 150 through each of the inner layer 154 and the outer layer 152 may be adapted to absorb or scatter—more than reflect—light, such that any amount of light passing through the vent is directed away from a direct line of sight of the wearer. In variations, the first material from which the inner layer 154 of the eye cup 150 is formed may have a maximum reflectance of 90% of light incident thereon, including a maximum reflectance of 85% of light incident thereon, including a maximum reflectance of 80% of light incident thereon, including a maximum reflectance of 75% of light incident thereon, including a maximum reflectance of 70% of light incident thereon, including a maximum reflectance of 65% of light incident thereon, and including a maximum reflectance of 60% of light incident thereon. In the same or other variations, the second material from which the outer layer 152 of the eye cup 150 is formed may have a maximum reflectance of 25% of light incident thereon, including a maximum reflectance of 20% of light incident thereon, including a maximum reflectance of 15% of light incident thereon, including a maximum reflectance of 10% of light incident thereon, and including a maximum reflectance of 5% of light incident thereon.

In variations, the eye cup 150 may include a locking tab 160a and/or an unlock tab 160b, such as is illustrated in FIG. 5. Such tabs 160a, 160b may be formed on the inner layer 154 of the eye cup and may be designed to assist with aligning the outer layer 152 and the inner layer 154 with one another during construction, thereby ensuring that the channels of the vents 156 are aligned with one another, such as is illustrated in FIG. 8. The locking tab 160a and the unlocking tab 160b may also be useful rotary references when removing or installing the eye cup150 onto the frame 140.

As illustrated in FIGS. 2, 5, 6, 9A, and 10, the ophthalmic device 100 may, in variations, include a nose pad 158. The nose pad 158 may, in variations, be integrally formed within the eye cup 150. By integrally forming the nose pad 158 within the eye cup 150, the nose pad 158 and the eye cup 150 may collectively form a substantially gapless seal against the wearer's face (e.g., a portion of the wearer's nose or other surrounding facial structures), such as is illustrated in FIG. 10. The gapless seal is generally configured to retard light from passing therethrough, similar to the seal created between the remained of the eye cup 150 and the wearer's face as described herein. As a result, in variations, the eye cup 150 (including the nose pad 158 integrally formed therein) may be designed to create a full-or near-360° light-tight seal against the wearer's face, such that light is only capable of reaching the wearer's eye through the filter(s) or lens(es). In variations, the nose pad 158 may be formed from the same material (e.g., the first material described herein) as the inner layer 154 of the eye cup 150, such as a rigid plastic material. In the same or other variations, the outer layer 152 of the eye cup 150 may be wrapped about the inner layer 154 of the eye cup 150, as described herein, without being wrapped about the nose pad 158 integrally formed within the eye cup 150, such as is illustrated in FIG. 2 and FIG. 6. In variations, the nose pad 158 may define a smooth outer surface against which a portion of the wearer's nose is designed to be rested.

In variations, the ophthalmic device 100 may include a pair of fixed filters 114a, 114b. With reference again to FIGS. 1, 3, and 4, additional features of the ophthalmic device 100 that may be included in certain variations are described. In variations, the frame 104 may include a pair of lens holders 109a, 109b. In variations, a pair of lenses 114a, 114b may be mounted in a V-groove 170 (refer to FIG. 11B). Each lens of the pair of lenses 114a, 114b may, in variations, have a refractive power for correcting vision (e.g., may be prescription lenses) and be formed of suitable material, such as glass or plastic. In variations, each lens of the pair of lenses 114a, 114b may have a convex curved front surface. In variations, each lens of the pair of lenses 114a, 114b may have a flat front surface. In variations, each lens of the pair of lenses 114a, 114b may have a flat back surface. In variations, each lens of the pair of lenses 114a, 114b may have no corrective power, often referred to by those familiar with the art as being plano lenses.

In variations, the ophthalmic device 100 may further include a pair of rotating filter holders 112a, 112b, which may be rotatably mounted in a rotating filter groove 172 (refer to FIG. 11B) on respective ones of the pair of lens holders 109a, 109b. In variations, the ophthalmic device 100 may further include a pair of rotating filters 115a, 115b, which may be fixedly secured to respective ones of the pair of rotating filter holders 112a, 112b. The rotating filter holders 112a, 112b may, in variations, include a pair of disk-shaped tabs or handles 116a, 116b. In variations, the ophthalmic device 100 may further include a pair of fixed filters 114a, 114b, which may be fixedly secured to respective ones of the eye cups 150a, 150b.

In variations, the ophthalmic device 100 may further include a pair of fixed filters or lenses 122a, 122b, which may be fixedly secured within and/or protrude into respective ones of the eye cups 150a, 150b, such as via corresponding V-grooves 162a, 162b (refer to FIGS. 4, 5, and 12B). As illustrated in FIG. 12B, the V-groove 162b may, in variations, be configured to mount a corresponding filter or lens 122b on the inside diameter of the eye cup 150b as the corresponding mounting ring 130b connects the eye cup 150b to the frame 104 along the outer diameter. Such a design provides a space behind the V-groove 162b for mounting the filter or lens 122b and permitting the filter or lens 122b to extend toward the wearer's eye, which may be particularly advantageous for a wearer that is near-sighted and requires a negative filter or lens having a relatively flat curve bulging away from the wearer's eye and a larger diopter shorter radius back cut curve creating a meniscus lens that is thicker along the side than in the middle as illustrated in FIG. 12B. Additionally, providing one or more filters or lenses within the eye cup 150 (e.g., such that the filter is fixedly secured within and/or protrudes into the corresponding eye cup) may advantageously alleviate and/or obviate the need to mount additional optics in the frame front 103 thereby eliminating unnecessary weight and bulk for the correspond lens holder 109 and frame front 103, better balance the filter or lens to be situated further back on the wearer's nose rather than in front, provide easy access (e.g., for cleaning, removal, and/or installation) to both sides of the filter or lens 122 when eye cup 150 is detached from frame front 104, allow for the use of negative meniscus style lenses or filters, and/or enable the possibility of a multi-filter or multi-corrective lens optic system, such as to correct for aberrations and provide a clear image.

In variations, each of the filters 114a, 114b, 115a, 115b, 122a, 122b may be a linearly polarized lens having a linearly polarizing film sandwiched in a laminating material, such as cellulose, triacetate, plastic, or glass. In variations, any one or more of the lenses may include various types of coating, such as polarization coating, scratch-resistance coating, anti-reflection coating or ultraviolet (UV) blocking coating to meet any required UV A and UV B blocking specifications.

In variations, each rotating filter holder of the pair of rotating filter holders 112a, 112b may be formed of suitable material, such as plastic or metal, for securing a respective one of the pair of rotating filters 115a, 115b thereto. In variations, each rotating filter of the pair of rotating filters 115a, 115b may form a detachable part of the corresponding rotating filter holder 112a, 112b. In variations, the user may push the tab 116a, 116b to rotate the respective rotating filter holder 112a, 112b relative to the frame 104 (or, more specifically, relative to a plane of polarization defined by the fixed filters 114a, 114b, 122a, 122b), thereby causing the detachably-formed rotating filters 115a, 115b to rotate therewith. In variations, each lens holder of the pair of lens holders 109a, 109b may define a respective slot 111a, 111b (such as is illustrated in FIG. 1 and FIG. 11C), and each tab 116a, 116b may be adapted to travel within and along the respective slot 111a, 111b as the user pushes the respective tab 116a, 116b (refer to FIGS. 1-4) to rotate the respective rotating filter holder 112a, 112b relative to the respective lens holder 109a, 109b.

In variations, a fixed filter 114a, 114b may be fixedly secured in a corresponding V-groove 170 defined in the frame front 103 (refer to FIG. 11B). In variations, another fixed filter 122a, 122b may be fixedly secured in a corresponding V-groove 162 defined in the eye cup 150 (refer to FIG. 5 and FIG. 12B) and/or the fixed filter 122a, 122b may be fixedly mounted to the frame front 103 and protrude into the eye cup 150. In variations, a rotating filter 115a, 115b may be rotatably mounted, as described herein. Each rotating filter holder 112a, 112b may be rotated by a user, such as by manipulating a corresponding tab 116. As the user rotates one of the pair of rotating filter holders 112a, 112b, a respective one of the rotating filters 115a, 115b is rotated relative to the respective fixed filters 114a, 114b, 122a, 122b. In variations, the pairs of fixed filters 114a, 114b, 122a, 122b may be configured to be stationary (i.e., not to rotate relative to the frame 104) and polarized in a first direction, such as the vertical orientation when the wearer is sitting or standing, so as to reject light that is polarized in a horizontal direction. In variations, the pair of rotating filters 115a, 115b disposed between the pairs of fixed filters 114a, 114b, 122a, 122b may be rotated by the user to have their respective axes of polarization oriented in the vertical direction, the horizontal direction, or in a direction between the vertical direction and the horizontal direction (i.e., may be polarized in a second direction) when the wearer is sitting or standing.

In variations, when the polarization direction of the rotating filter 115a, 115b is aligned parallel to the polarization direction of the fixed filters 114a, 114b, 122a, 122b, the amount of light passing through the rotating and fixed filters may be at its maximum. Likewise, when the polarization direction of the rotating filter 115a, 115b is aligned perpendicular to the polarization direction of the fixed filter 114a, 114b, 122a, 122b, the amount of light passing through the rotating and fixed filters may be at its minimum. In this way, the rotating and fixed filters may substantially block light to the wearer's eye(s). In variations, the angle between the polarization directions of the rotating and fixed filters may determine the amount of light that passes through the rotating and fixed filters. In variations, the length of each slot 111a, 111b along its circumferential direction is long enough so that the angle between the polarization directions of the rotating and fixed filters ranges from 0 to at least 90 degrees to reach the maximum and minimum attenuations. Light that reflects off of horizontal surfaces such as bodies of water or a car hoods at an acute angle becomes predominantly horizontally polarized, and by having the fixed filters oriented to pass vertically polarized light and block horizontally polarized light, the ophthalmic device 100 may minimize this source of glare similar to conventional sunglasses.

It is noted that, in variations, the user may be able to rotate each of the pair of rotating filter holders 112a, 112b individually so that the amount of light to each eye is adjusted separately. For instance, a patient suffering from binocular diplopia may wear the ophthalmic device 100 and rotate one or more of the rotating filter holders 112a 112b separately to block one eye or the other to eliminate double vision. Also, in variations, the user may be able to shift the eye that is being blocked by rotating the rotating filter holders 112a, 112b separately.

In variations, each lens holder of the pair of lens holders 109a, 109b may have indicators (not shown) that are arranged along its circumferential direction, and each tab of the pair of tabs 116a, 116b may include an indicator groove (not shown). In variations, each indicator may indicate the amount of attenuation created by the rotating and fixed filters when the indicator groove is aligned with the indicator.

In a variation, the ophthalmic devices of the present disclosure may be usable as or adapted for use as variable optical density (OD) ophthalmic devices, such as by including one or more layers of polarizing filters.

In variation, the ophthalmic device 100 may allow a wearer with photophobia to effectively prevent light from passing through to the wearer's eyes except through the lenses, such as by ensuring that the eye cups seal tightly against the wearer's face (including the wearer's nose and eye sockets) to block light from passing through any gaps that might otherwise exist between the ophthalmic device and the wearer's face, as described herein.

In variations, the ophthalmic device 100 may allow a wearer with binocular diplopia to effectively block one eye or the other, eliminating double vision. For at least some wearers, this may be preferred to a conventional eye patch since the wearer may want to allow both eyes to work at different times and stay strong. Additionally, in variations, there may be a level of attenuation that eliminates double vision but does not leave the heavily attenuated eye completely useless for detecting objects that is out of the field of vision of the unattenuated eye.

In variations, conventional transition coating may achieve up to an optical density 2 or 100× attenuation on a bright sunny day. In variations, the ophthalmic device 100 may be able to achieve optical density of 3 to 4 or 1000 to 10,000× attenuation, depending on the number of filters, the polarization efficiency, and the angle of the filters on the face relative to the line of sight. Furthermore, since transition coatings depend on UV light from the sun to activate (cause them to darken) they are not effective when light is passing through a car or home window that is designed to or naturally blocks UV light. Man-made sources of light may be irritating to some people but typically do not contain sufficient UV to activate the coating. Ophthalmic device 100 does not suffer from these shortcomings as it allows for user input from the wearer to add or subtract attenuation.

It is noted that while the filters are illustrated as having a flat disk shape, those skilled in the art will recognize that such filters may be curved so that one or both of the front and rear surfaces are concave to the eyes. Such curvature may, in variations, be employed to enhance overall performance by making the polarizer surface closer to normal for all the rays of light contained in the cone of light that can reach the eye(s).

In one variation, any of the ophthalmic devices described herein may include two pairs of polarizing filters fixedly mounted on the frame (one pair for each eye) and a pair of rotating filter holders (containing polarized filters) rotatably mounted in the frame. The rotating filter holders may be configured to be individually rotated relative to the frame so that an amount of light passing through one of the polarizing filters toward a respective eye of the wearer is adjusted separately from an amount of light passing through the other of the polarizing filters and toward the other eye of the wearer.

In another variation, any of the ophthalmic devices described herein may be or may be adapted as a two filter ophthalmic device. The two filter ophthalmic device may include a system of filters and holders. One fixed filter holder may contain a vertically oriented (when the wearer is sitting or standing) linear polarizing filter. Such fixed filter holder may have a rail that extends in front of the fixed filter and follows a circular rotating filter holder. The rotating filter may be mounted in the rotating filter holder, which may have a V groove that allows the rotating filter holder to “snap in” to the rail of the fixed filer holder. A tab on the rotating holder may contain the rotating filter and be configured to be pushed clockwise or counterclockwise, thereby enabling the filter to rotate and cross with the fixed filter. For light entering normal to the filters, approximately 34% of light may pass therethrough and reach the eye when the polarization directions of the rotating and fixed filters are oriented parallel to each other. When the polarization directions of the rotating and fixed filters polarization axis are perpendicular to each other (i.e., when the filters are cross-polarized), only approximately 0.05% of the light entering normal to the filters may pass therethrough.

In yet another variation, any of the ophthalmic devices described herein may be or may be adapted as a three filter ophthalmic device. The three filter ophthalmic device may include a pair of fixed filter holders incorporated into the eyewear frame or securely mounted thereto. The pair of fixed filter holders and a pair of rings may be configured to hold the two pairs of fixed vertically oriented (when the wearer is sitting or standing) linear polarizing filters. The pair of fixed filter holders and the pair of rotating rings may be configured to prevent the two pairs of fixed filters to move and sandwich the pair of rotating filter holders that is allowed to rotate in between the two pairs of fixed filters. As each of the pair of rotating filters rotates, the rotating filter may cross with the orientation of the first entrance filter and the last exit filter that effectively attenuate randomly polarized light coming from the sun and/or most forms of indoor lighting. Such a three filter ophthalmic device may achieve more attenuation than the two filter ophthalmic device, assuming that the three filter ophthalmic device and the two filter ophthalmic device employ equivalent filters. When all three filters are arranged parallel to each other, approximately 26% of light may pass therethrough and reach the eye. When the two pairs of fixed filters are arranged perpendicular (i.e. crossed) to the rotating filter, approximately 0.002% of light may pass therethrough and reach the eye. Those skilled in the art will appreciate that this third filter can also clean up areas of uneven attenuation within the special field of view caused by light passing through the filters off-normal, effects of the substrate on the polarized light, or other non-linear polarization effects.

In still another variation, in any of the ophthalmic devices described herein, the first fixed filter (i.e., the filter farthest from the wearer's eye) and/or the last fixed filter (i.e., the filter closest to the wearer's eye) may be replaced with a glass or acrylic optic (e.g., a lens or filter), which may have refractive power for correcting vision (i.e., may be a “prescription lens”). This optic may be vertically oriented linearly polarized similar to the plano filter it replaces.

The mount for any of the polarized optics (lenses or filters) described herein may have a pair of V-grooves for mounting a pair of lenses therein, and each pair of V-grooves may have a pair of notches that transect the V-grooves for ensuring the optic does not rotate in the mount and is rotationally oriented correctly (i.e., the rotational orientation of the axis of polarization is correct to enable cross polarization, the rotational orientation cylindrical power to correct for astigmatism and the rotational orientation of any prisms to correct for eye misalignment). Each of a pair of fixed (front and back) optics may have a refractive power for correcting vision and may have a convex curved front surface. Each of the pairs of optics may have various coatings, such as scratch resistant coating, antireflective coating, and/or UV blocking coating.

Any ranges cited herein are inclusive unless specifically stated otherwise. The terms “substantially,” “approximately,” and “about” used throughout this disclosure are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

1. An ophthalmic device, comprising:
a frame;
at least one eye cup detachably mounted to the frame, the at least one eye cup comprising an inner layer formed from a first material and an outer layer formed from a second material different from the first material, wherein the outer layer is at least partially wrapped about the inner layer;
a nose pad integrally formed within the at least one eye cup, the nose pad and the at least one eye cup collectively forming a substantially gapless and substantially light-tight seal configured to retard light from passing therethrough; and
a plurality of air vents formed through both the outer layer and the inner layer of the at least one eye cup, each of the plurality of air vents defined by a first channel extending through the outer layer and a second channel extending through the inner layer,
wherein a centerline of the first channel through the outer layer of the eye cup is angularly offset from a centerline of the second channel through the inner layer of the eye cup, and
wherein the first channel extends from an environment external to the eye cup to a point where the centerline of the first channel intersects the centerline of the second channel and the second channel extends from the point where the centerline of the first channel intersects the centerline of the second channel to an environment internal to the eye cup.

2. The ophthalmic device of claim 1, wherein the centerline of the first channel is angularly offset from the centerline of the second channel by from 5° to 175°.

3. The ophthalmic device of claim 1, wherein the centerline of the first channel is angularly offset from the centerline of the second channel by from 45° to 135°.

4. The ophthalmic device of claim 1, wherein the centerline of the first channel is angularly offset from the centerline of the second channel by from 80° to 100°.

5. The ophthalmic device of claim 1, wherein the centerline of the first channel is angularly offset from the centerline of the second channel by 90°.

6. The ophthalmic device of claim 1, wherein at least either:
(a) the centerline of the first channel is angularly offset from a direction normal to an inner surface of the outer layer at the point where the centerline of the first channel intersects the centerline of the second channel by from 5° to 85°; or
(b) the centerline of the second channel is angularly offset from a direction normal to an inner surface of the inner layer at the point where the centerline of the first channel intersects the centerline of the second channel by from 5° to 85°.

7. The ophthalmic device of claim 1, wherein at least either:
(a) the centerline of the first channel is angularly offset from a direction normal to an inner surface of the outer layer at the point where the centerline of the first channel intersects the centerline of the second channel by from 35° to 65°; or
(b) the centerline of the second channel is angularly offset from a direction normal to an inner surface of the inner layer at the point where the centerline of the first channel intersects the centerline of the second channel by from 35° to 65°.

8. The ophthalmic device of claim 1, wherein at least either:
(a) the centerline of the first channel is angularly offset f from a direction normal to an inner surface of the outer layer at the point where the centerline of the first channel intersects the centerline of the second channel by 45°; or
(b) the centerline of the second channel is angularly offset from a direction normal to an inner surface of the inner layer at the point where the centerline of the first channel intersects the centerline of the second channel by 45°.

9. The ophthalmic device of claim 1, wherein the centerline of the first channel is angularly offset from a direction normal to an inner surface of the outer layer at the point where the centerline of the first channel intersects the centerline of the second channel and the centerline of the second channel is angularly offset from a direction normal to an inner surface of the inner layer at the point where the centerline of the first channel intersects the centerline of the second channel.

10. The ophthalmic device of claim 1, wherein the frame includes:
a frame front; and
at least one temple arm connected to the frame front via an end piece and extending rearwardly away from the frame, the at least one temple arm including a hinge space apart from the end piece and configured to permit a portion of the at least one temple arm to be folded inwardly without contacting the at least one eye cup.

11. The ophthalmic device of claim 10, wherein the hinge is disposed between a first portion of the at least one temple arm and a second portion of the at least one temple arm, such that the second portion is configured to be folded inwardly with respect to the first portion without contacting the at least one eye cup.

12. The ophthalmic device of claim 1, further comprising at least one filter fixedly secured within or protruding into the at least one eye cup.

13. The ophthalmic device of claim 1, wherein the first material from which the inner layer is formed is a rigid plastic material.

14. The ophthalmic device of claim 13, wherein the first material from which the inner layer is formed is configured to block at least 95% of light incident thereon from passing therethrough.

15. The ophthalmic device of claim 1, wherein the second material from which the outer layer is formed is a flexible rubber material or a silicone material.

16. The ophthalmic device of claim 1, wherein the nose pad is formed from the first material and the outer layer is not wrapped about the nose pad.

17. The ophthalmic device of claim 1, wherein the at least one eye cup comprises two layers consisting of the inner layer and the outer layers.

18. The ophthalmic device of claim 1, wherein the point is located where the outer layer mates with the inner layer and the first channel interfaces with the second channel, such that the first channel and second channel are aligned with one another.

19. The ophthalmic device of claim 18, wherein the first channel and the second channel are reflectionally symmetrical about the point.

20. An ophthalmic device, comprising:
a frame;
at least one eye cup detachably mounted to the frame, the at least one eye cup comprising two layers consisting of an inner layer formed from a first material and an outer layer formed from a second material different from the first material, wherein the outer layer is at least partially wrapped about the inner layer;
a nose pad integrally formed within the at least one eye cup, the nose pad and the at least one eye cup collectively forming a substantially gapless and substantially light-tight seal configured to retard light from passing therethrough; and
a plurality of air vents formed through both the outer layer and the inner layer of the at least one eye cup, each of the plurality of air vents defined by a first channel extending through the outer layer and a second channel extending through the inner layer,
wherein a centerline of the first channel through the outer layer of the eye cup is angularly offset from a centerline of the second channel through the inner layer of the eye cup,
wherein the first channel extends from an environment external to the eye cup to an intersection point where (a) the centerline of the first channel intersects the centerline of the second channel, (b) the outer layer mates with the inner layer, and (c) the first channel interfaces with the second channel, such that the first channel and second channel are aligned with one another, and
wherein the second channel extends from the intersection point to an environment internal to the eye cup.
